(19) United States
(12) Patent Application Publication
(10) Pub. No.: US 2024/0277149 A1
(43) Pub. Date: Aug. 22, 2024

(54) SHOOTING REST CHAIR

(71) Applicant: AOB Products Company, Columbia, MO (US)

(72) Inventors: Seth Wheeler, Columbia, MO (US); Timothy S. Kinney, Warrenton, MO (US); Ryan Varnum, Columbia, MO (US); Ryan Lovold, Columbia, MO (US); Aaron Wood, Columbia, MO (US); Michael Cottrell, Ashland, MO (US); Matthew Kinamore, Columbia, MO (US); James Tayon, Moberly, MO (US)

(73) Assignee: AOB Products Company, Columbia, MO (US)

(21) Appl. No.: 18/653,117

(22) Filed: May 2, 2024

Related U.S. Application Data
(63) Continuation of application No. 17/659,222, filed on Apr. 14, 2022, now Pat. No. 12,004,658.
(60) Provisional application No. 63/175,361, filed on Apr. 15, 2021.

(51) Int. Cl. A47C 4/52; A01M 31/02; A47C 3/18; A47C 4/44; A47C 7/62

(52) U.S. Cl. CPC A47C 4/52; A01M 31/02; A47C 3/18; A47C 4/44; A47C 7/62

(57) ABSTRACT

A shooting rest chair, components thereof, and associated methods. The shooting rest chair includes a base configured to rest on a support surface. A seat supported by the base is sized and shaped to support a shooter when the shooter is sitting in the seat. A pivot hub is supported by the base and connects the base to the seat. A weapon support arm assembly connects to the pivot hub by a first pivot connection. The weapon support arm assembly is configured to support the weapon and is pivotable with respect to the base and the seat about the first pivot connection.

### CROSS-REFERENCE TO RELATED APPLICATION

The present application is a continuation of and claims priority to U.S. application Ser. No. 17/659,222, filed Apr. 14, 2022, which claims priority to U.S. Provisional Application No. 63/175,361, filed Apr. 15, 2021, the entireties of which are hereby incorporated by reference.

### FIELD

The present disclosure generally relates to firearm shooting accessories, and more particularly to a stowable shooting rest chair that is adaptable for left and right handed shooters.

### BACKGROUND

Shooting rest chairs are used to support and stabilize a shooter firing a firearm and usually also to support and stabilize the firearm being fired. Some shooting rest chairs have limitations when it comes to being adaptable for left and right handed shooters.

### SUMMARY

In one aspect, a shooting rest chair for supporting a shooter and a weapon above a support surface comprises a base, a seat, a pivot hub, and a weapon support arm assembly. The base is configured to rest on the support surface. The seat is supported by the base, and the seat is sized and shaped to support the shooter when the shooter is sitting on the seat. The pivot hub is supported by the base and connects the base to the seat. The weapon support arm assembly is connected to the pivot hub by a first pivot connection. The weapon support arm assembly is configured to support the weapon. The weapon support arm assembly is pivotable with respect to the base and the seat about the first pivot connection.

In another aspect, a portable chair for supporting a person above a support surface comprises a base and a seat. The base is configured to rest on the support surface and is configurable in a deployed configuration and in a collapsed configuration. The seat includes a holder under the seat, and the seat is supported by the base. The seat is sized and shaped to support the person when the person is sitting in the seat. The portable chair is configurable in an operational configuration and in a stowed configuration.

Other objects and features of the present disclosure will be in part apparent and in part pointed out herein.

### BRIEF DESCRIPTION OF THE DRAWINGS

FIG. 1 is a perspective of a shooting rest chair;

FIG. 2 is a perspective of a base of the chair;

FIG. 3 is a perspective of a seat and weapon support arm assembly of the chair;

FIG. 4 is an exploded perspective of a connection of the base, seat, and weapon support arm assembly;

FIG. 5 is an exploded perspective of a first pivot connector;

FIG. 6 is a fragmentary cross-section of the connection of the base, seat, and weapon support arm assembly;

FIG. 7 is a fragmentary cross-section of the base, seat, and weapon support arm assembly; and

FIG. 8 is a bottom perspective of the shooting rest chair.

Corresponding reference numbers indicate corresponding parts throughout the drawings.

### DETAILED DESCRIPTION

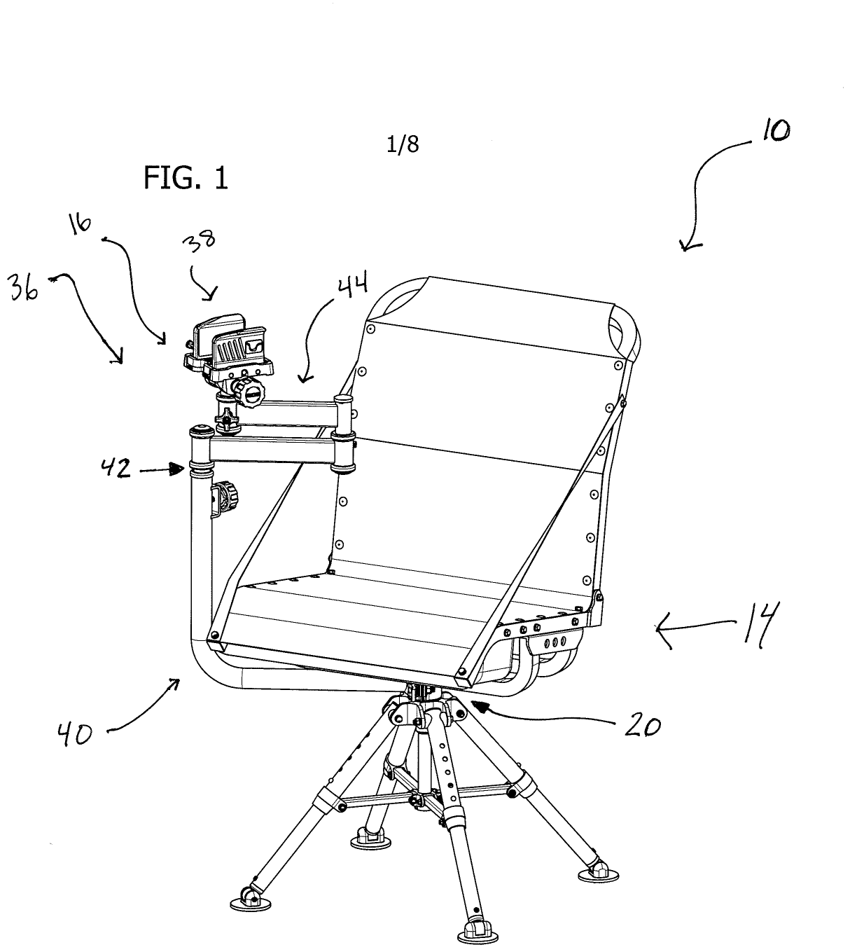

Referring to FIG. 1, the shooting rest chair 10 is designed to support a sitting person (e.g., a shooter) and a firearm to be fired by the person. As will become apparent, the shooting rest chair 10 is configurable between operational and stowed configurations. In the operational configuration, the shooting rest chair is adjustable to adapt for left-handed and right-handed shooters.

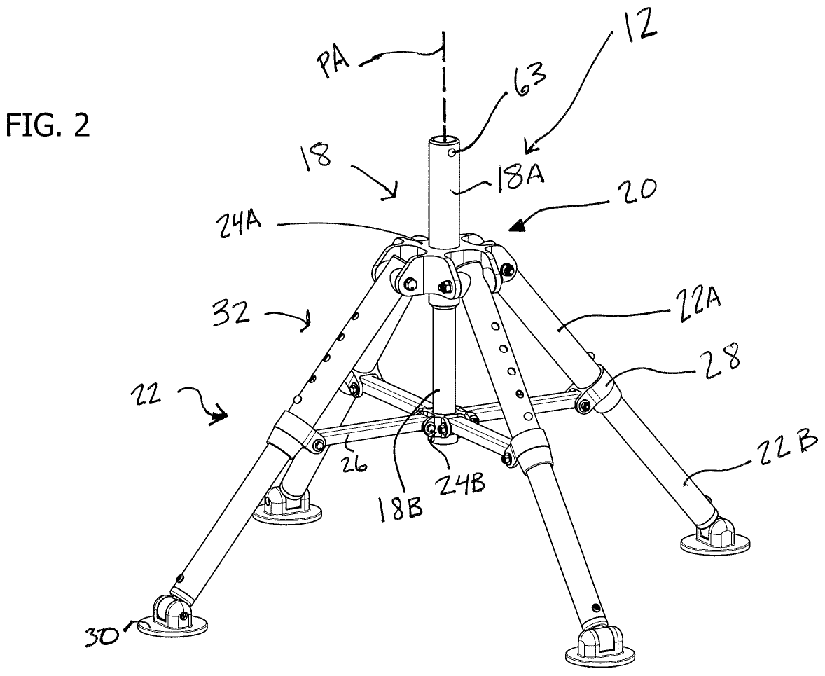

Referring to FIGS. 1-3, the shooting rest chair 10 generally includes a base 12 and a seat 14 (chair components) that together make up (broadly, “a chair”), and a weapon support arm assembly 16. The seat and weapon support arm assembly are pivotable with respect to each other about a post 18 supported by the base which defines a generally vertical pivot axis PA. As will be explained in further detail, the post 18 pivotably supports the weapon support arm assembly 16 at the top of the base and below the seat 14 (broadly, “pivot connection”) to permit the weapon support arm assembly to rotate to left and right sides of the seat, thereby allowing the shooting rest chair 10 to be usable by left-handed and right-handed shooters.

The base 12 includes a plurality of legs 22, upper (first) and lower (second) post portions 18A, 18B, upper (first) and lower (second) collars 24A, 24B, and pivot links 26. The upper post portion 18A and upper collar 24A form a pivot hub 20 to which the seat 14 and weapon support arm assembly are pivotably connected. Together, the upper and lower post portions 18A, 18B form the post 18 (column) that defines the pivot axis PA that permits pivotable rotation of the chair and the weapon support arm assembly. As will become apparent, the post portions are supported by the plurality of legs 22. In the illustrated embodiment, the upper and lower post portions 18A, 18B can be extended (deployed) and retracted (collapsed) by a telescoping post connection. The upper collar 24A is an unthreaded “O” collar that defines a hollow interior that extends around upper post portion 18A. The upper collar 24A includes an exterior having four pivot connectors, one for each leg, spaced apart around the exterior of the upper collar. Likewise, the lower collar 24B is an unthreaded “O” collar that defines a hollow interior that extends around the lower post 18B. The lower collar 24B includes an exterior having four pivot connectors, one for each pivot link 26, spaced apart around the exterior of the lower collar. The upper and lower collars 24A and 24B are sized and shaped to engage the respective upper and lower posts, 24A and 24B, respectively. In the illustrated embodiment, the upper collar 24A is sized and shaped to be larger than the lower collar 24B.

Each of the legs 22 includes an upper (first) leg portion 22A a lower (second) leg portion 22B, and a leg connector collar 28, and has an associated pivot link 26. The upper leg portion 22A includes a proximal end pivotably connected to the upper collar 24A. The lower leg portion 22B has a proximal end telescopically received in the distal end of the upper leg portion 22A. The leg connector collar 28 assists the telescopic connection of the upper leg portion and the lower leg portion. Feet 30 are connected to the distal ends of the lower leg portions 22B for contacting the ground (broadly, “support surface”). The pivot links 26 connect the leg connector collar 28 to the pivot connectors of the lower collar 24B. Retainers 32 (e.g. spring biased detents) carried by the lower leg portions 22B are receivable in a series of openings in the upper leg portions 22A for selectively adjusting a length of each leg.

The base 12 is configurable between a deployed configuration and a collapsed configuration. FIGS. 1, 2, and 8 show the base 12 in the deployed configuration. In the deployed configuration, the legs are arranged to engage the support surface to support the seat above the support surface. For example, the support surface can be an exterior surface such as turf, pavement, and/or gravel, etc. or can be an interior surface such as a floor.

When the base 12 is in the deployed configuration, the four legs 22 are extended outward from the pivot hub 20 to the ground. Each leg forms about a 45-degree angle with respect to the pivot axis PA. The pivot links 26 are extended in a direction transverse the pivot axis PA to provide support to the base via connection to the lower post portion 18B. It will be appreciated that the upper post 18A protrudes upward to be exposed above the upper collar 24A. Bases having other configurations (e.g., more or fewer legs) can be used without departing from the scope of the present disclosure.

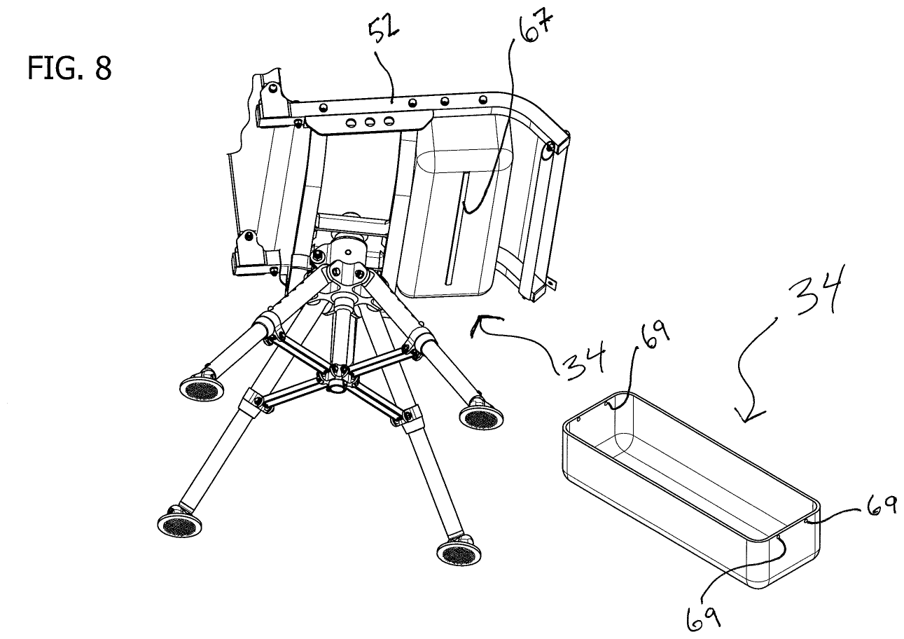

When the base 12 is in a collapsed configuration (not shown), the four legs are folded inward toward the lower post portion 18B so each leg is about parallel with respect to the pivot axis PA. The lower post portion 18B is retracted into the upper post portion 18A and the pivot links 26 are pivoted inward toward the pivot axis PA. Further, the lower leg portion 22B is retracted into the upper leg portion 22A such that the detent carried by the proximal end of the lower leg portion is generally near the proximal end of the upper leg portion. As will be explained below, when in the collapsed configuration, the base 12 is sized and shaped to fit in a holder 34 located under the seat 14. FIG. 8 shows two instances of the holder 34, one connected to the seat, and another removed from the seat.

Referring to FIGS. 1, 3, and 4, the weapon support arm assembly 16 is configured to rotate about the upper post portion 18A (pivot axis PA) to left and right sides of the seat 14 for respective left and right handed shooters. The weapon support arm assembly 16 comprises an arm 36 and a weapon holder (broadly, “weapon rest”) 38. The arm comprises first, second, and third arm portions, 40, 42, and 44. The first arm portion includes a first segment 40A and a second segment 40B. A proximal end of the first segment 40A includes a first pivot connector 40C configured to pivotably connect to the upper post portion 18A when the upper post portion is in the deployed configuration. The first segment 40A extends distally from the first pivot connector 40C located at the pivot hub 20 laterally outward a distance sufficient to extend outboard of a periphery of the seat. The first segment 40A has a length longer than a length of the center of the seat 14 to an edge of the seat. The second segment 40B of the first arm portion 40 includes a proximal end connected to the first arm segment 40A below the seat 14, and the second segment 40B extends distally to a distal end above the seat. The second segment 40B is generally upstanding (e.g., generally parallel with the generally vertical pivot axis PA). Other configurations of a weapon support arm assembly can be used without departing from the scope of the present disclosure.

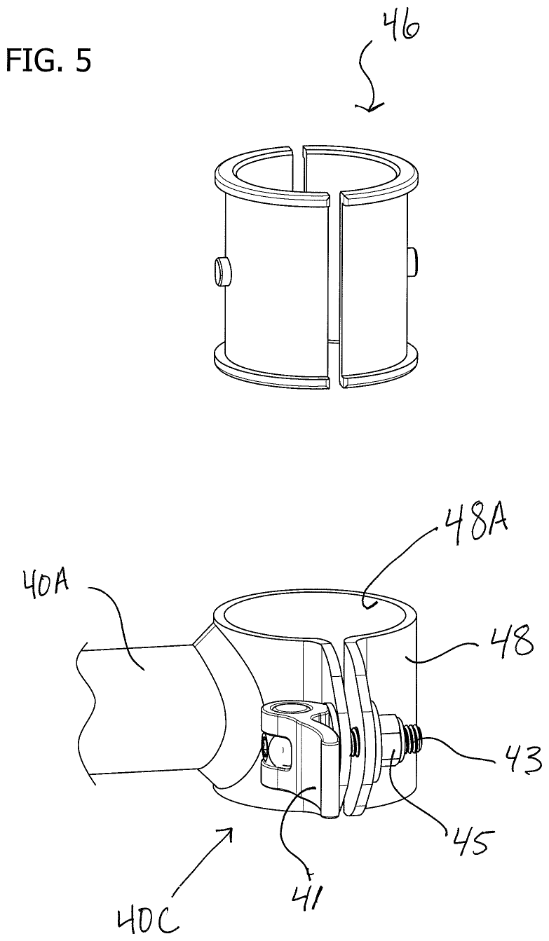

Referring to FIGS. 5-7, the pivot connector 40C includes a bushing 46 and an adjustable collar 48. The adjustable collar 48 may be welded to the proximal end of the first segment 40A. The bushing 46 is sized and shaped to be received in the collar 48 and engage an inner surface 48A of the collar. The bushing 46 may be made from Delrin or a POM material that snaps into the collar to prevent movement. The collar 48 (e.g., made of metal) includes a slot, a cam lever 41, a fastener 43 (e.g., bolt), and a nut 45 (broadly, “adjusting components.”) The cam lever is arranged to reduce a width of the slot when in a closed position (e.g., FIG. 5) and to permit the slot width to increase when in an open position. The nut 45 is threaded onto the fastener 43 such that the cam lever 41 cams against the collar 48 to draw flanges of the collar toward each other to reduce the width of the slot between the flanges. After initially adjusting the nut 45 with a wrench, the cam lever 41 can be used to permit tightening or loosening of the collar 48 without tools. The collar 48 may be tight to prevent pivoting of the weapon support with respect to the seat, or can be loose to permit pivoting of the weapon support with respect to the seat, per the preference of the user. The location of the first pivot connector 40C (at the pivot hub 20) permits the first segment 40A, and thus the weapon support arm assembly 16, to rotate freely about the pivot axis PA.

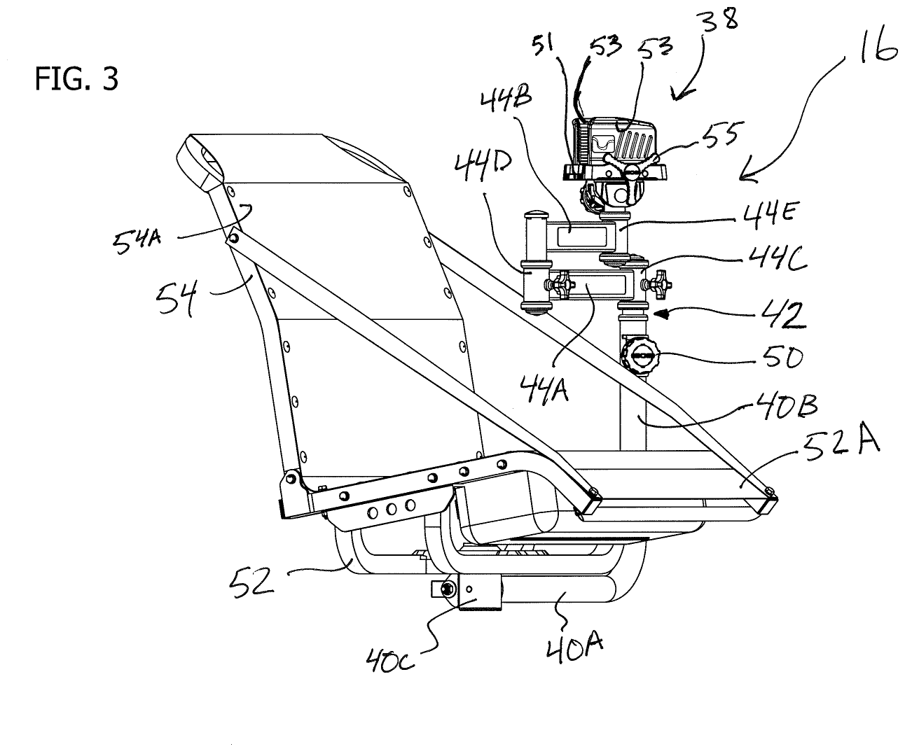

Referring to FIGS. 1 and 3, the second arm portion 42 is arranged between the first and third arm portions 40, 44. (Only a small portion of the second arm portion 42 is depicted in the FIGS. 1 and 3.) The second arm portion 42 permits the shooter to selectively raise or lower the height of the weapon holder 38. The second arm portion 42 includes a tube having a lower end, an upper end, and a length extending therebetween. The second arm portion 42 is telescopically received in the second segment 40B such that the lower end of the tube remains within the second segment 40B. A retainer 50 (e.g. rotatable friction knob) is connected to the second segment 40B and permits the user to selectively lock the second arm portion 42 to set a distance the second arm portion extends upward out of the second segment 40B. Other ways of adjusting the height of the weapon holder (e.g. a detent, etc.) can be used without departing from the scope of this disclosure.

The third arm portion 44 includes first and second sections 44A, 44B each having respective opposite ends. The first section 44A includes a second pivot connector 44C for connecting the first section 44A to the second arm portion 42. The first section 44A includes a third pivot connector 44D for connecting to the second section 44B. The second section 44B includes a fourth pivot connector 44E for connecting to the weapon holder 38. In the illustrated embodiment, the first and second sections 44A, 44B via the second and third pivot connectors 44C, 44D permit the shooter to selectively adjust the lateral position of the weapon holder 38 with respect to the seat 14.

The weapon holder 38 includes a cradle comprising a bed 51 and opposing jaws 53 for clamping a weapon (e.g. firearm). The weapon holder 38 includes a clamp actuator 55 (e.g., rotatable knob) configured to move the first and second jaws 53 toward and away from each other to clamp and release the weapon. The weapon holder 38 is adjustable (e.g. pivotable about multiple axes) to change an orientation of the weapon with respect to the chair 10. Other types of weapon holders (e.g. without clamping) can be used without departing from the scope of the present disclosure. As will be discussed below, the weapon support arm assembly 16 (e.g., including the weapon holder 38, and arm portions 40, 42, 44) and the seat 14 are independently pivotable with respect to each other such that both can rotate 360 degrees (broadly, at least 180 degrees, or at least 90 degrees) with respect to each other. The weapon support arm assembly 16 can pivot in front of the seat 14 to left or right sides of the seat and can pivot behind the seat.

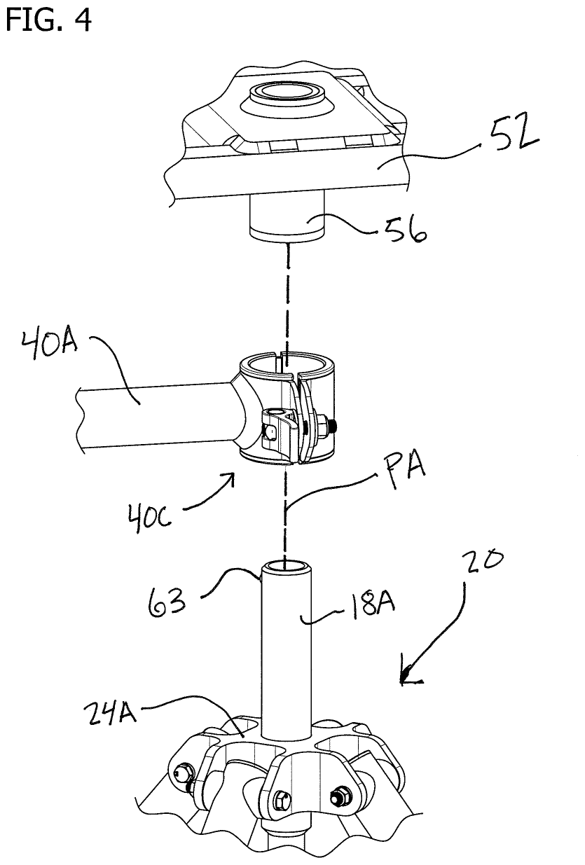

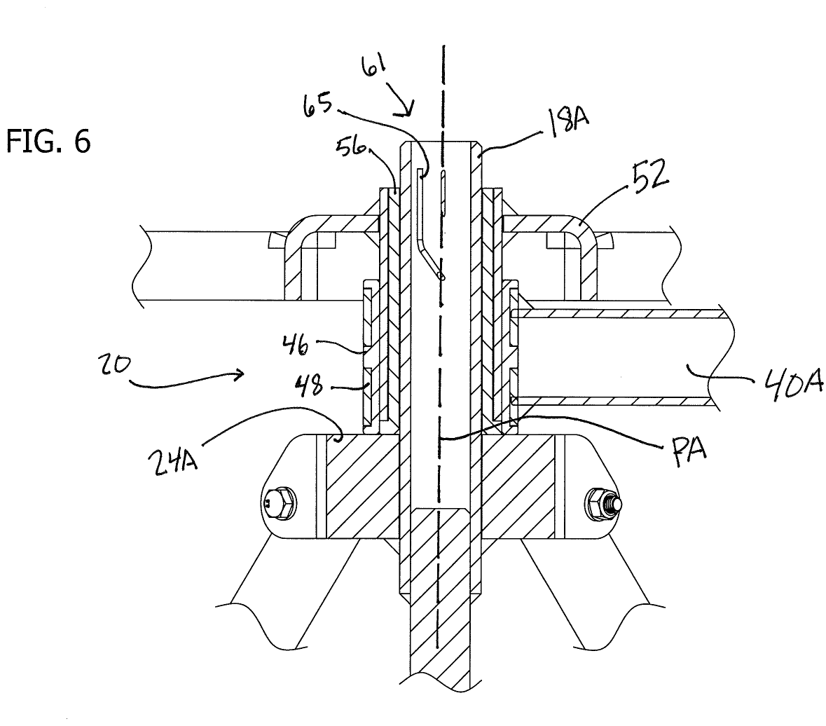

Referring to FIGS. 3 and 4, the seat 14 includes a seat frame 52 and a seat panel 52A connected thereto. In the illustrated embodiment, a backrest including a backrest frame 54 and a backrest panel 54A is pivotably connected to the seat 14. The backrest is shown in FIG. 3 in a deployed configuration in which it extends upward from the seat 14. It will be appreciated that the backrest is foldable downward toward the seat 14 to a folded configuration. Support straps connect the seat frame 52 to the backrest frame 54 to support the backrest in the deployed configuration. The seat frame 52 includes a seat tube 56 (broadly, “pivot hub connector”) for connecting the seat frame 52 to the upper post portion 18A. The seat tube 56 is a hollow tube welded to the frame and sized and shaped for sliding over the upper post portion 18A. As shown in FIG. 6, when the seat tube 56 is received over the upper post portion, the arm connector 40C (including the collar 48 and bushing 46) are received over the seat tube 56, such that both the seat and support arm assembly 16 are pivotably connected to the pivot hub 20. The seat 14, support arm assembly 16, and base 12 can be disassembled by releasing the cam lever 41, and separating the base downward from the seat and support arm assembly, and separating the support arm assembly downward from the seat. A spring detent 61 including a lug 63 (FIG. 4) and a spring 65 (FIG. 6) is provided to prevent inadvertent upward removal of the seat 14 from the base 12, and the lug can be pressed inward by the user to permit removal of the seat tube 56 past the lug.

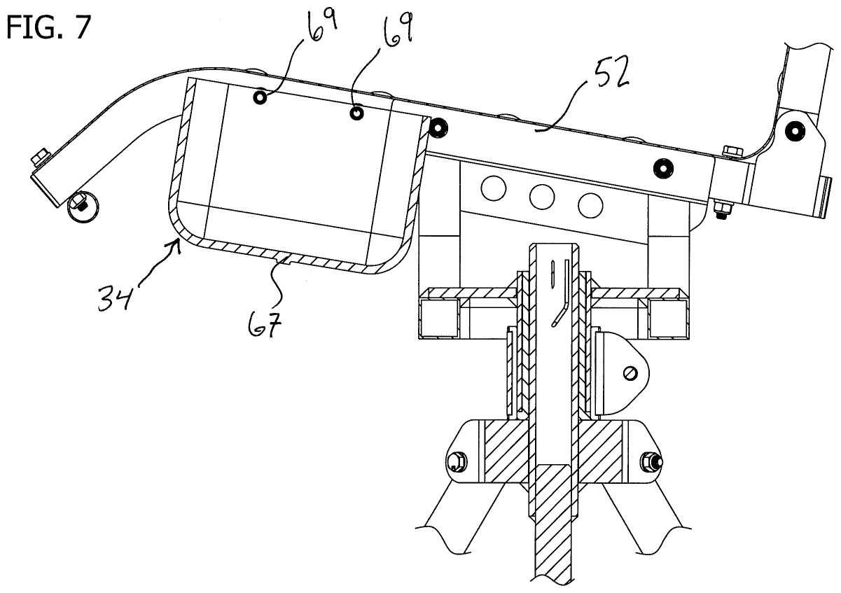

Referring to FIGS. 7 and 8, the holder 34 is connected to the seat frame 52 for holding the base 12 when the base is in a collapsed configuration. In the illustrated embodiment, the holder 34 includes a container formed of a flexible fabric forming a bag-like enclosure. A zipper 67 may be provided for opening and closing the holder 34. The holder may include grommets 69 (openings) through which fasteners are passed to secure the holder to the frame 52. In other embodiments, the holder may include straps (e.g. Velcro®, button snaps, etc.) fastened to the frame 52 for holding the base 12 to the seat when in the stowed configuration.

It will be understood that the shooting rest chair 10 is configurable to operational and stowed configurations. To configure the shooting rest chair 10 in the operational configuration, the base is configured in its deployed configuration as described above. With the cam lever 41 in its open position, the user places the weapon support arm assembly 16 over the seat tube 56 such that an outer surface of the seat tube engages an inner surface of the bushing 46. The user then places the seat tube 56 over the upper post portion 18A such that the seat and support arm assembly 16 are pivotably connected to the pivot hub 20. As the seat tube 56 is installed over the upper post portion 18A, the user presses the detent 61 (retainer) inward and it resiliently extends outward when the seat tube has passed over the detent. The detent 61 serves to retain the seat 14 on the upper post portion 18A when in the operational configuration. The collar 48 of the weapon support arm assembly 16 is secured using the cam lever 41, such that the collar is permitted to pivot relative to the seat tube or locked relative to the seat tube, depending on the setting of the nut 45 on the fastener 43. To disassemble the shooting rest chair 10 and configure it in the stowed configuration, the user first unlocks the cam latch. The user then presses the detent with the user's finger and lifts the seat 14 up from the upper post portion 18A. Next, the user removes the weapon support arm assembly 16 by lifting it up from the upper post portion 18A. The user then collapses the base 12 to the collapsed configuration as described above and places the collapsed base into the holder 34 under the seat 14.

It will be apparent that modifications and variations are possible without departing from the scope of the invention defined in the appended claims. The dimensions and proportions described herein are by way of example without limitation. Other dimensions and proportions can be used without departing from the scope of the present disclosure.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A shooting rest chair for supporting a shooter and a weapon above a support surface, the shooting rest chair comprising:
a base configured to rest on the support surface;
a seat supported by the base, the seat being sized and shaped to support the shooter when the shooter is sitting on the seat;
a pivot hub supported by the base, the pivot hub connecting the base to the seat;
a weapon support arm assembly connected to the pivot hub by a first pivot connection, the weapon support arm assembly being configured to support the weapon, the weapon support arm assembly being pivotable with respect to the base and the seat about the first pivot connection.

2. The shooting rest chair of claim 1, wherein the weapon support arm assembly includes an arm and a weapon rest, and wherein the arm is configured to extend under the seat from the pivot hub and upward to a connection of the arm to the weapon rest above the seat.

3. The shooting rest chair of claim 2, wherein the arm includes a first arm portion, a second arm portion, and a third arm portion, the first arm portion being coupled to the second arm portion by a height adjustment connection and the second arm portion being connected to the third arm portion by a second pivot connection.

4. The shooting rest chair of claim 3, wherein the first arm portion includes a first segment and a second segment, the first segment extending laterally away from the pivot hub under the seat, and the second segment extending upward from the first segment to a distal end of the second segment above the seat, the second segment being connected to the second arm portion by the height adjustment connection, and the second arm portion being connected to the third arm portion by the second pivot connection.

5. The shooting rest chair of claim 4, wherein the third arm portion includes a first section and a second section, the first section being connected to the second section by a third pivot connection.

6. The shooting rest chair of claim 5, wherein the first section is connected to the second arm portion by the second pivot connection.

7. The shooting rest chair of claim 6, wherein the rest is connected to the second section by a fourth pivot connection.

8. The shooting rest chair of claim 7, wherein the rest comprises a cradle for holding the weapon.

9. The shooting rest chair of claim 8, wherein the cradle comprises a bed and first and second jaws, at least one of the jaws being moveable with respect to the bed to clamp the weapon between the jaws.

10. The shooting rest chair of claim 1, wherein the rest comprises a bed and first and second jaws, at least one of the jaws being moveable with respect to the bed to clamp the weapon between the jaws.

11. The shooting rest chair of claim 1, wherein the weapon support arm assembly is configured to permit pivoting of the weapon support arm assembly from a left side of the seat to a right side of the seat across a front of the seat to change a configuration of the weapon support arm assembly between a left handed shooter arrangement and a right handed shooter arrangement.

12. The shooting rest chair of claim 11, wherein the weapon support arm is configured to permit pivoting of the weapon support arm in at least 90 degrees of motion with respect to the seat.

13. The shooting rest chair of claim 11, wherein the weapon support arm is configured to permit pivoting of the weapon support arm in at least 180 degrees of motion with respect to the seat.

14. The shooting rest chair of claim 11, wherein the weapon support arm is configured to permit pivoting of the weapon support arm in 360 degrees of motion with respect to the seat.

15. The shooting rest chair of claim 1, wherein the seat is pivotable with respect to the base, and the weapon support arm assembly is pivotable with respect to the base independent from the seat.

16. The shooting rest chair of claim 15, wherein the pivot hub defines a pivot axis and the seat and weapon support arm are configured to pivot about the pivot axis.

17. The shooting rest chair of claim 1, wherein the base comprises a plurality of legs coupled to the pivot hub, each leg comprising a lower end configured to engage the support surface.

18. The shooting rest chair of claim 17, wherein the legs are configurable in a deployed configuration and a collapsed configuration.

19. A portable chair for supporting a person above a support surface, the portable chair comprising:
a base configured to rest on the support surface, the base being configurable in a deployed configuration and in a collapsed configuration;
a seat including a holder under the seat, the seat supported by the base and being sized and shaped to support the person when the person is sitting on the seat;
wherein the portable chair is configurable in an operational configuration and in a stowed configuration.

20. The portable chair of claim 19, wherein when the chair is in the operational configuration the base is in the deployed configuration and connected to the seat to support the seat above the support surface and when the chair is in the stowed configuration the base is in the collapsed configuration and held by the holder under the seat.
